(19) United States
(12) Patent Application Publication
(10) Pub. No.: US 2002/0061447 A1
(43) Pub. Date: May 23, 2002

(54) Battery electrode, production method thereof, and battery

(75) Inventors: Toshiaki Kanno, Shizuoka (JP); Makoto Katsumata, Shizuoka (JP); Hidenori Yamanashi, Shizuoka (JP); Hitoshi Ushijima, Shizuoka (JP)

Correspondence Address: ARENT FOX KINTNER PLOTKIN & KAHN, PLLC, SUITE 400, 1050 CONNECTICUT AVENUE, N.W., WASHINGTON, DC, 20036-5339, US

(73) Assignee: YAZAKI CORPORATION

(21) Appl. No.: 10/053,903

(22) Filed: Jan. 24, 2002

Related U.S. Application Data
(63) Continuation of application No. 08/462,747, filed on Jun. 5, 1995.
Application No. 08/462,747 is a continuation of application No. 08/252,041, filed on May 24, 1994, now abandoned.
Application No. 08/252,041 is a continuation of application No. 08/063,705, filed on May 20, 1993, now abandoned.

(30) Foreign Application Priority Data
May 25, 1992 (JP) 4-132391

(51) Int. Cl. H01M 4/58; C01B 31/02

(52) U.S. Cl. 429/231.8; 423/445 R; 428/408; 423/448; 264/44; 264/29.7; 264/105; 429/231.95; 264/29.1

(57) ABSTRACT

An electrode for secondary battery made of carbon material is provided, which is light in weight while excellent in charge-discharge properties and in durability in repetitive use. A material for electrode is obtained by intermixing a synthetic resin with vapor-phase growth carbon fibers to make the vapor-phase growth carbon fibers uniformly dispersed in the synthetic resin to obtain a mixture, molding the mixture into a predetermined shape to obtain a molded product, and heating the molded product at high temperature to convert it into a carbon-carbon composite material. The electrode for battery is made of thus obtained carbon-carbon composite material.

### BACKGROUND OF THE INVENTION

1. Field of the Invention

The present invention relates to an electrode used in a secondary battery. More particularly, the invention relates to a battery electrode made of a carbon-carbon composite material.

2. Description of the Related Art

It is heretofore known that a graphite carbon material can be used as a positive electrode active material of non-aqueous electrolyte secondary battery. In detail, in case that the graphite carbon material is used as a positive electrode in a secondary battery using an electrolyte for example of lithium perchlorate, an electron is emitted simultaneously when a perchloric ion is inserted into between graphite layers to form an intercalation compound. It is thus preferable that a highly graphitized carbon material, which can have a large mass of inclusion compound, that is, which can readily synthesize the intercalation compound of low stage, be used as an electrode to provide a large charge and discharge electric quantity.

Nevertheless, if a highly graphitized carbon material such as the natural graphite is used to increase the charge and discharge electric quantity per unit weight, inclusion and exclusion of ions during charge and discharge would cause the carbon material to be gradually broken and powdered. Vapor-phase growth carbon fibers are highly graphitizable, but they are unsuitable for forming a high density shape of electrode, because they are fine discontinuous fibers. Therefore, it is difficult to enhance the charge-discharge electric quantity per unit weight of electrode using the vapor-phase growth carbon fibers, so that there has been no practical electrode made of the vapor-phase growth carbon fibers.

### SUMMARY OF THE INVENTION

It is, therefore, an object of the present invention to provide an electrode for secondary battery made of a carbon material, which is light in weight, and excellent in charge-discharge properties and in durability in repetitive use.

The present invention achieved the above object by forming a battery electrode from an electrode material of carbon-carbon composite material in which vapor-phase growth carbon fibers are uniformly dispersed in a carbon matrix.

The vapor-phase growth carbon fibers used to make the electrode of the present invention may be obtained as follows. A raw material is a hydrocarbon compound selected from aromatic hydrocarbons such as toluene, benzene, and naphthalene; and aliphatic hydrocarbons such as propane, ethane, and ethylene. A preferable raw material is benzene or naphthalene. The raw material is first gasified, and is introduced with a carrier gas for example of hydrogen, carbon dioxide, or carbon monoxide to a reaction zone heated at 900-1500° C. The raw material is then made in contact with a catalyst made of a super fine metal in the reaction zone at 900-1500° C. Examples of the catalyst are ion, nickel, and ion-nickel alloy in particle diameter of 100-300 angstroms. Upon the contact, the raw material is thermally decomposed to form vapor-phase growth carbon fibers.

The thus obtained carbon fibers are subjected to a heat treatment in atmosphere of inert gas such as argon at temperature of 1500-3500° C., preferably of 2000-3000 ° C., for 3-120 minutes, preferably for 30-60 minutes, turning into graphite fibers having a three dimensional crystal structure in which the carbon hexagonal network (graphite-like structure) is oriented substantially in parallel with the fiber axis like annual rings. However, the conditions of high temperature heat treatment should be preferably determined taking into consideration a balance as an electrode between the charge-discharge properties and the durability property. A high degree of graphitization tends to promote decomposition of electrolyte solvent such as propylene carbonate. Therefore, a battery would rather prefer a not too high degree of graphitization in order to enhance the durability as a battery.

The thus obtained vapor-phase growth carbon fibers are intermixed with a synthetic resin, which is a precursor of the matrix in the carbon-carbon composite material. By the mixing, the vapor-phase growth carbon fibers are uniformly dispersed in the synthetic resin so as to form a composite compound. The synthetic resin may be any resin which can form a carbon matrix, and may be properly selected from thermoplastic resins and thermosetting resins. An example of synthetic resin is a phenolic resin. The mixing is carried out using an appropriate mixer, for example the two-roller mill, the kneader, the Intermix, and the Banbury mixer. A formulation amount of the vapor-phase growth carbon fibers may be within a range of 30-90 weight % in the composite compound, preferably 50-80 weight %. If the formulation amount exceeds the above range, the formability is degraded, while if the formulation amount is lowered below the above range, the electrode cannot have excellent charge-discharge properties.

Various additives such as processing aid may be formulated in the composite compound as far as they do not interrupt the function of electrode.

The thus obtained composite compound is formed into a desired shape, preferably into a desired electrode shape by a proper forming method, for example the injection molding, the extrusion, the compression molding, the HIP molding, and the powder compacting. The molded product thus obtained can be immediately subjected to carbonization. In case that a thermoplastic resin is used as binder, the composite material may be first subjected to a heat treatment in oxygen-containing atmosphere to effect infusibilization, and then be subjected to carbonization.

The carbonization may be conducted in a heating furnace in atmosphere of inert gas, for example nitrogen, helium, argon, neon, or a mixture gas thereof, while heating the product at a ratio of temperature increase for example of 1-10° C./min up to about 1000° C. After the carbonization, the product is further subjected to a heat treatment in atmosphere of inert gas such as argon at a temperature above 2000° C. in a super high temperature furnace to promote graphitization. A preferable rate of temperature increase is not more than 10° C./min for graphitization.

The thus obtained carbon-carbon composite material may be used as a battery electrode without modification, but may also be processed into a suitable shape with necessity.

The electrode using the carbon-carbon composite material according to the present invention contains fine vapor-phase growth carbon fibers uniformly dispersed in the carbon matrix moderately graphitized, so that it has high conductivity and numerous fine pores. For example, if the electrode of the present invention is used as an electrode for lithium secondary battery, a battery may be obtained with excellent charge-discharge properties and durability.

As described, the battery electrode of the present invention uniformly contains the graphitized vapor-phase growth carbon fibers, which are easy to produce the intercalation compound in the carbon matrix, whereby the battery with the electrode may show excellent charge-discharge properties and durability while being light in weight.

Further objects and advantages of the present invention will be apparent from the following description of the preferred embodiments with reference to the accompanying drawings.

### BRIEF DESCRIPTION OF THE DRAWINGS

FIG. 1 is a drawing to show a construction of a battery for test for evaluating charge-discharge properties of a positive electrode;

FIG. 2 is a graph to show charge-discharge properties of battery O which employs an electrode of the present invention as a positive electrode;

FIG. 3 is a graph to show charge-discharge properties of battery P which employs an electrode of comparative example as a positive electrode;

FIG. 4 is a drawing to show a construction of a battery for test for evaluating charge-discharge properties in combination of a positive electrode and a negative electrode;

FIG. 5 is a graph to show charge-discharge properties of battery Q which employs two electrodes of the present invention, one as a positive electrode and the other as a negative electrode; and

FIG. 6 is a graph to show charge-discharge properties of battery R which employs two electrodes of comparative example, one as a positive electrode and the other as a negative electrode.

### DESCRIPTION OF THE PREFERRED EMBODIMENTS

A mixture gas of benzene and hydrogen was brought into contact with particles of metal ion catalyst in particle diameter of about 300 angstroms in an electric furnace at 900-1000° C. to be thermally decomposed then to form vapor-phase growth carbon fibers in diameter of 0.01-0.5 μm and in length of 5-300 μm. The carbon fibers were then heated at 2000° C., at 2600° C., or at 3000° C. for a half hour to obtain graphitized vapor-phase growth carbon fibers X, Y, or Z.

### EXAMPLE 1

60 weight parts of the above graphitized vapor-phase growth carbon fibers Y and 40 weight parts of a phenolic resin (PGA 2165 from Gun-ei Chemical Industry Co., Ltd. (Gun-ei Kagaku Kogyo)) were uniformly intermixed with each other by a ball mill. The mixture was compressed at 180° C. for twenty minutes to obtain a plate of 70 mm×10 mm×2 mm. Then, a sample was cut out from the plate in size of 10 mm×10 mm×2 mm.

The sample was then heated at a rate of temperature increase of 5° C./min up to 1000° C. in nitrogen flow so as to be carbonized. The carbonized sample was further heated at 2000° C. in argon flow for thirty minutes to obtain a carbon-carbon composite material A.

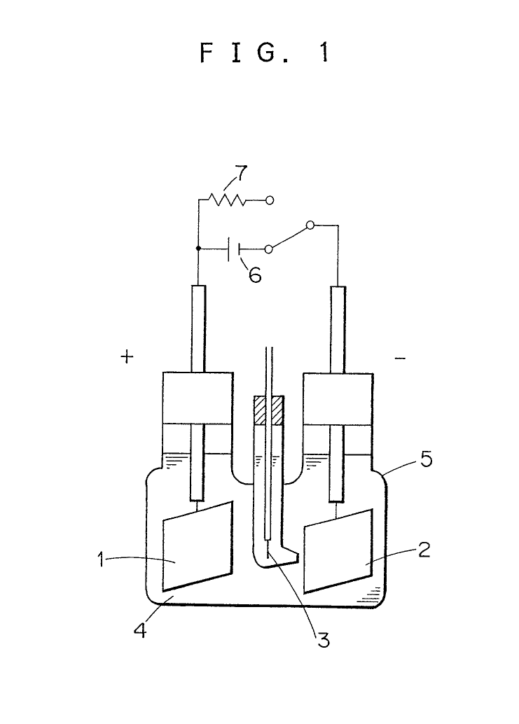

The carbon-carbon composite material A was set as a positive electrode 2 in a battery for test as shown in FIG. 1, and a metal lithium plate as a negative electrode 1. In FIG. 1, reference numeral 3 denotes a platinum reference electrode, numeral 4 an electrolyte of propylene carbonate containing lithium perchlorate, numeral 5 a battery container, numeral 6 a power source for charge, and numeral 7 a galvanostat.

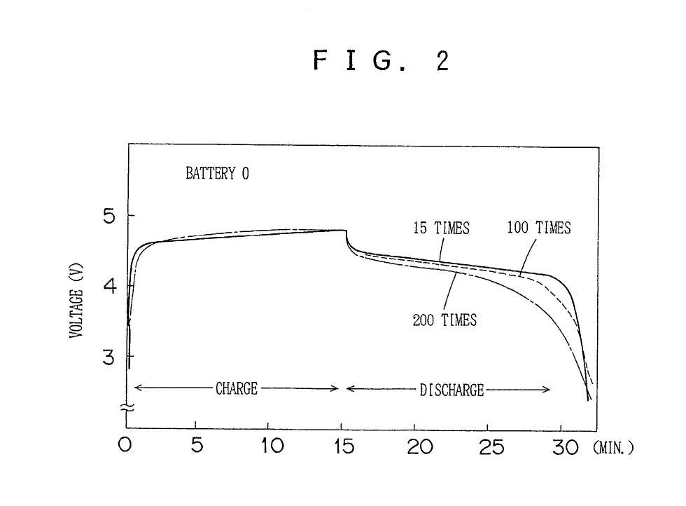

FIG. 2 shows results of continuous measurements of charge-discharge properties using the battery O.

### Comparative Example 1

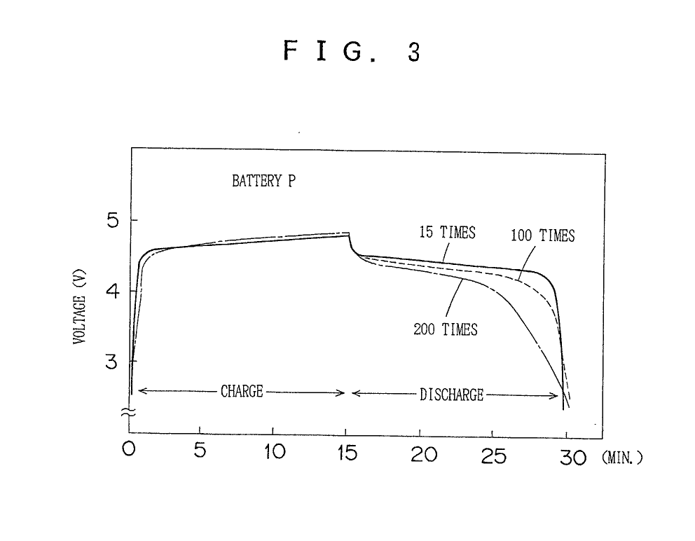

A composition was prepared using 60 weight parts of the same graphitized vapor-phase growth carbon fibers Y as those in Example 1 and 40 weight parts of powdered polyethylene resin. The composition was compressed to obtain a composite material B. Battery P was formed using this composite material B as a positive electrode 2 in the same manner as in Example 1. FIG. 3 shows test results of measurements of charge-discharge properties using the battery P.

Comparing the test results of FIG. 2 with those of FIG. 3, it is seen that the electrode of the present invention has a large capacity of charge and discharge, and a long life.

### EXAMPLE 2

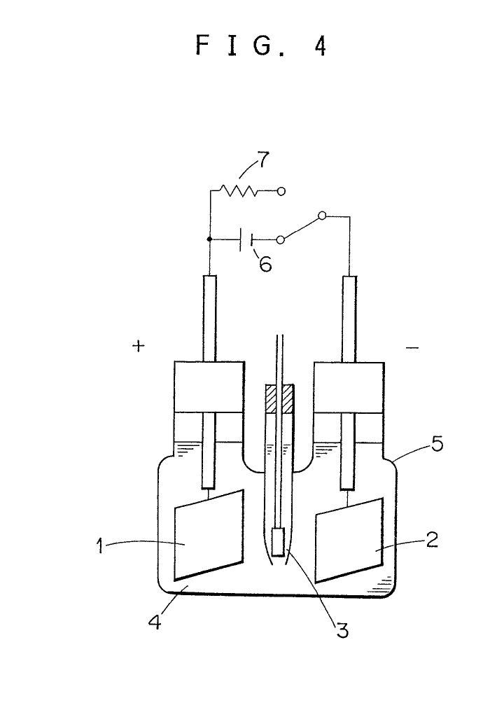

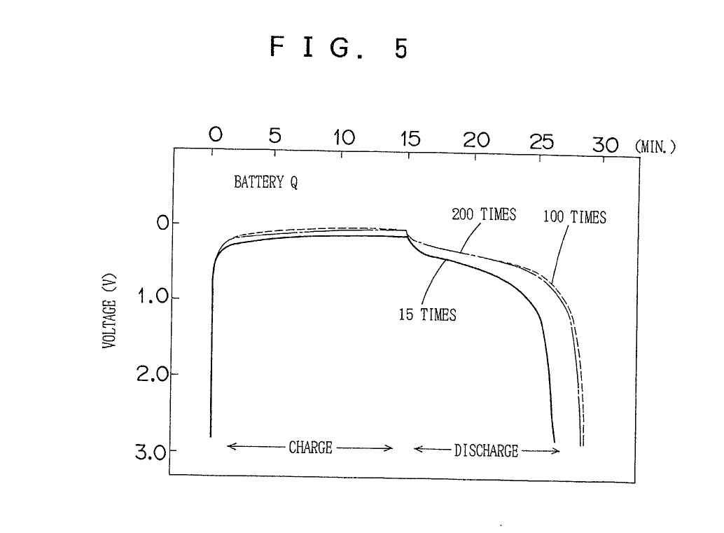

A carbon-carbon composite material C was prepared in the same manner as in Example 1 except that the graphitized vapor-phase growth carbon fibers X were used instead of the graphitized vapor-phase growth carbon fibers Y. Also, a carbon-carbon composite material D was prepared by using the graphitized vapor-phase growth carbon fibers Z instead of the graphitized vapor-phase growth carbon fibers Y, carbonizing the mixture in the same manner as in Example 1, and further heating the carbonized product at 2800° C. for thirty minutes. A secondary battery was formed using the above carboncarbon composite material C as a negative pole 1 and the above carbon-carbon composite material D as a positive electrode 2, obtaining the battery for test as shown in FIG. 4. This battery had a lithium reference electrode 3′ in place of the platinum reference electrode 3 in the battery of FIG. 1. FIG. 5 shows test results of measurements of charge-discharge properties using the thus obtained battery 9 of the present invention.

### Comparative Example 2

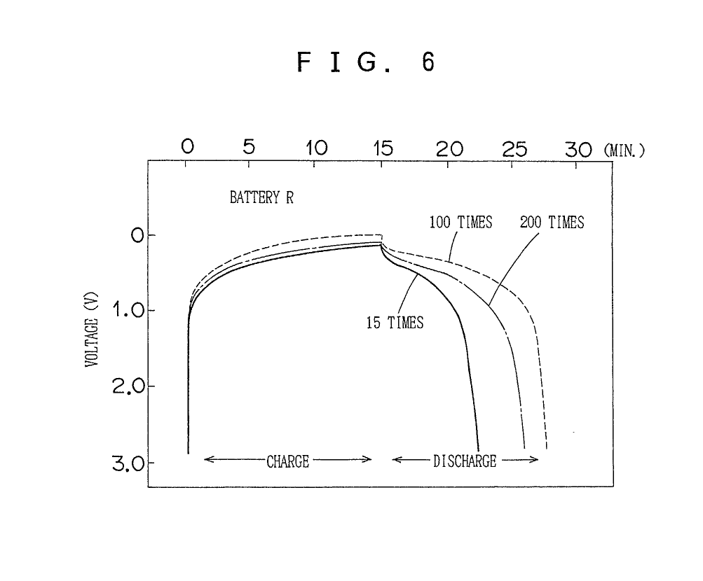

A composite material E was prepared in the same manner as in comparative example 1 except that the graphitized vapor-phase growth carbon fibers X were used instead of the graphitized vapor-phase carbon fibers Y. Also, a composite material F was prepared in the same manner as comparative example 1 except that the graphitized vapor-phase growth carbon fibers Z were used instead of the graphitized vapor-phase growth carbon fibers Y. A second battery R was then formed using the above composite material E as a negative electrode 1 and the above composite material F as a positive pole 2, obtaining the battery for test similar to that of Example 2. FIG. 6 shows test results of measurements of charge-discharge properties using the secondary battery R.

Comparing the test results, it is seen that the electrodes of the present invention have a large capacity of charge and discharge, and a long life.

Many embodiments and modifications may be constructed without departing from the scope of the present invention. It should be understood that the present invention is not limited to the specific embodiments as described above.

What is claimed is:

1. A battery electrode made of a carbon-carbon composite material in which vapor-phase growth carbon fibers are uniformly dispersed in a carbon matrix.

2. A battery electrode according to claim 1, wherein said vapor-phase growth carbon fibers are subjected to graphitization.

3. A battery electrode according to claim 1, wherein a precursor of said carbon matrix is a synthetic resin.

4. A battery electrode according to claim 1, wherein a formulation amount of said vapor-phase growth carbon fibers is 30-90 weight %.

5. A battery electrode according to claim 1, wherein a formulation amount of said vapor-phase growth carbon fibers is 50-80 weight %.

6. A battery electrode according to claim 1, wherein said carbon-carbon composite material is subjected to graphitization.

7. A method for producing the battery electrode as set forth in claim 1, comprising:
intermixing a synthetic resin with vapor-phase growth carbon fibers to make said vapor-phase growth carbon fibers uniformly dispersed in said synthetic resin to obtain a mixture;
molding said mixture into a predetermined shape to obtain a molded product; and
heating said molded product at high temperature to convert it into a carbon-carbon composite.

8. A method for producing the battery according to claim 7, further comprising a step of graphitizing said vapor-phase growth carbon fibers.

9. A method for producing the battery according to claim 7, wherein said heating step at high temperature includes carbonization and graphitization.

10. A battery comprising:
a positive electrode formed of the electrode as set forth in claim 1;
a negative electrode; and
an electrolyte into which said positive electrode and said negative electrode are immersed.

11. A battery according to claim 10, wherein said negative electrode is made of a carbon-carbon composite material in which vapor-phase growth carbon fibers are uniformly dispersed in a carbon matrix.

12. A battery according to claim 10, wherein said negative electrode is a metal lithium plate.

13. A battery according to claim 10, wherein said battery is a lithium secondary battery.

14. A battery according to claim 13, wherein said electrolyte contains lithium perchlorate.

15. A battery according to claim 10, wherein said vapor-phase growth carbon fibers are subjected to graphitization.

16. A battery according to claim 10, wherein a precursor of said carbon matrix is a synthetic resin.

17. A battery according to claim 10, wherein a formulation amount of said vapor-phase growth carbon fibers is 30-90 weight %.

18. A battery according to claim 10, wherein a formulation amount of said vapor-phase growth carbon fibers is 50-80 weight %.

19. A battery according to claim 10, wherein said carbon-carbon composite material is subjected to graphitization.
